(19) United States
(12) Patent Application Publication
(10) Pub. No.: US 2010/0128674 A1
(43) Pub. Date: May 27, 2010

(54) Method of Responding DeletePersonalityRequest Message in Ultra Mobile Broadband

(75) Inventor: Xiaowu Zhao, Shenzhen City (CN)

Correspondence Address: WOODCOCK WASHBURN LLP, CIRA CENTRE, 12TH FLOOR, 2929 ARCH STREET, PHILADELPHIA, PA, 19104-2891, US

(73) Assignee: ZTE CORPORATION, Shenzhen City (CN)

(21) Appl. No.: 12/596,123

(22) PCT Filed: Apr. 14, 2008
(86) PCT No.: PCT/CN08/70708

§ 371 Date: Oct. 15, 2009

(30) Foreign Application Priority Data
Apr. 18, 2007 (CN) 200710093784.7

(51) Int. Cl. H04W 74/00

(52) U.S. Cl. 370/328

(57) ABSTRACT

A method of responding a Delete Personality Request message in Ultra Mobile Broadband is disclosed. The Delete Personality Request message is sent to the access terminal by the access network through an air interface in Ultra Mobile Broadband. When the access network requests to delete one or more personalities, the access terminal sends a Delete Personality Accept message to the access network with the following information: Message ID, Transaction ID, Personality Count and Personality Index, wherein, Personality Count is determined by the access terminal according to the number of the personalities which the access terminal agrees to delete, and the information of Personality Index is one or more personalities that the access terminal agrees to delete. Compared with the prior art, the present invention enhances the personality management mechanism in the UMB system and saves the signaling interaction overhead of the air interface and the air interface resource.

### TECHNICAL FIELD

The present invention relates to Ultra Mobile Broadband technology, and more specifically, to a method for responding the Delete Personality Request message in Ultra Mobile Broadband.

### BACKGROUND

At present, an evolution of the corresponding access technologies in the near future are researched and developed in different access technology fields of the wireless communication to offer the performance of the corresponding systems and networks and the service capability. UMB (Ultra Mobile Broadband) is a new technology of evolved from CDMA2000 access technology. Many technologies for the UMB air interface can greatly improve the performance of the communication network based on CDMA2000 access technology, thus lay an essential foundation to offer more wireless multimedia services which meet more requirements of the users.

During the process of designing seamless handoff, the design idea is proposed in UMB that each eBS (evolved base station) in the active set of AT (Access Terminal) and the AT have their own protocol stacks respectively. Each eBS in the active set has a set of negotiated Personalities. Each eBS and AT respectively decide what Personality is applied in the protocol stack between them. One Personality is defined as a set of complete negotiated protocol sub-types, application sub-types, attributes, non-attribute data and public data (which can be used as examples for a protocol or an application). Several Personalities are represented by different indexes.

Referring to FIG. 1 for the above, the active set has three evolved base stations for supporting UMB, represented by eBS1, eBS2 and eBS3 respectively, wherein, different personality indexes, such as personality A, personality B, personality C and personality D, are included in the Session Info of each eBS. Session Signature X represents the session signature X and indicates that the personality A of eBS1 is the protocol or application example in using after AT negotiates with eBS1, and indicates that personalities C of eBS2 and eBS3 are the protocols or application examples in using respectively after AT negotiates with eBS2 and eBS3.

In this technology, the management for Personality is very important, since it determines the effective protocol stack which can be successfully negotiated by the AT with each eBS. In the prior art, the following related messages associated with the deletion of Personality are defined:

(1) Delete Personality Request Message

This message is used when the access network (eBS or AN) requests the AT to delete one or more Personalities, and the format of the message is shown as Table 1:

TABLE 1
the format of Delete Personality Request message

| Field | Length (bits) |
|---|---|
| Message ID | 8 |
| Transaction ID | 8 |
| Personality Count | 4 |

Personality Count instances of the following record

| | |
|---|---|
| Personality Index | 4 |
| Reserved | 0-7 as needed |

There is a blank row between the Personality Index field and the Reserved field, which means that the times are counted only when Personality Index appears.

Wherein,

Message ID: the access network shall set it as 0x0d.

Transaction ID: the access network shall increment this value for each new Delete Personality Request message sent.

Personality Count: the access network shall set this field to the number of Personality Index fields in this message.

Personality Index: the access network shall set this field to the personality which access network is requesting to delete. The access network shall order the list in decreasing preference for deletion.

Reserved: This field shall be set to reserved bits to make the length of the entire message equal to an integer number of octets. These bits shall be set to ‘0’.

(2) Delete Personality Accept Message

The message is used when the access terminal shows the access network the personalities to be deleted, and the format of the message is shown as Table 2:

TABLE 2
the format of Delete Personality Accept message

| Field | Length (bits) |
|---|---|
| Message ID | 8 |
| Transaction ID | 8 |
| Personality Index | 4 |
| Reserved | 0-7 as desired |

Wherein,

Message ID: the access terminal shall set it to 0x0e.

Transaction ID: the access terminal shall set this field to the value of the corresponding field in the Delete Personality Request message accepted.

Personality Index: the access terminal shall set this field to the personality deleted.

Reserved: This field shall be set to reserved bits to make the length of the entire message equal to an integer number of octets. These bits shall be set to ‘0’.

(3) Delete Personality Reject Message

This message is used by the access terminal to reject the Delete Personality Request from the access network, and its format is shown as Table 3:

TABLE 3
the format of Delete Personality Reject message

| Field | Length (bits) |
|---|---|
| Message ID | 8 |
| Transaction ID | 8 |
| Reject Reason | 8 |
| Reserved | 0-7 as needed |

Wherein,

Message ID: the access network shall set it to 0x0f.

Transaction ID: the access terminal shall set this field to the value of the corresponding field in the Delete Personality Request message rejected.

Reject Reason: the access terminal shall set this field to indicate the reason the Delete Personality Request message is rejected. Reserved: This field shall be set to reserved bits to make the length of the entire message equal to an integer number of octets. These bits shall be set to ‘0’.

There might have several reasons for the Delete Personality Request message to be rejected, and the encoding of the value is shown in Table 4:

TABLE 4
Reject Reason Values

| Values | Reason |
|---|---|
| 00000000 | Personality currently InUse |
| All other values | Reserved |

From the format of the Delete Personality Accept message shown in FIG. 2, it can be seen that the Delete Personality Accept message includes only one personality which can be deleted. However, the Delete Personality Request message shown in Table 1 can carry several Personalities to be deleted as desired. Therefore, if the access terminal uses the Delete Personality Accept message in the prior art to response the Delete Personality Request message from the access network, there will be un-correspondent somewhat. Moreover, for the case that the access network requests to delete several Personalities, the access terminal needs to send the Delete Personality Access message to the access network for several times, which wastes the air interface resource.

### SUMMARY OF THE INVENTION

The present invention offers a method for responding the Delete Personality Request message in the Ultra Mobile Broadband technology to solve the problem of air interface resource waste due to that the access terminal can only feed back the Delete Personality Accept message for deleting one Personality at one time when responding the Delete Personality Request message from the access network in the prior art.

In order to solve the above problem, the present invention first offers a method for responding the Delete Personality Request message in the Ultra Mobile Broadband technology, and said Delete Personality Request message is sent to the access terminal by the access network through the UMB air interface, wherein, when said access network requests to delete one or more Personalities, said access terminal sends one Delete Personality Access message including Message ID, Transaction ID, Personality Count and Personality Index to said access network, wherein, said Personality Count is determined by said access terminal according to the number of personalities which are agreed to be deleted, and said Personality Index is one or more personalities that said access terminal agrees to delete.

Furthermore, said Personality Count is the number of said Personalities that said access terminal agrees to delete.

The present invention further offers a method for the access terminal responding the Delete Personality Request in the UMB technology, and the method includes the following steps:

When the access network requests to delete one or more Personalities, it sends said Delete Personality Request message to said access terminal;

Said access terminal determines one or more Personalities which are agreed to be deleted, and then determines the number of the Personalities to be deleted;

Said access terminal sets the number of Personalities agreed to be deleted to Personality Count, the one or more Personalities agreed to be deleted as the information of Personality Index, and fills the Delete Personality Accept message with all these information, and sends the message to said access network.

The present invention also offers a method for responding the Delete Personality Request message in UMB technology, and said Delete Personality Request message is sent to the access terminal by the access network through said UMB air interface, and when said access network requests to delete one or more Personalities, said access terminal sends said a Delete Personality Response including Message ID, Transaction ID, AcceptIncld, Personality Count, Personality Index and Reject Reason to access network, wherein, said AcceptIncld is determined according to whether said access terminal agrees to delete the Personalities or not, said Personality Count is determined by said access terminal according to the number of the Personalities agreed to be deleted, and said Personality Index is one or more Personalities that said access terminal agrees to delete.

Furthermore, said Personality Count is the number of said Personalities that said access terminal agrees to delete.

Furthermore, said Reject Reason is not indicated if said AcceptIncld identifies that said access terminal agrees to delete said Personalities; and said Personality Count is not indicated if said AcceptIncld identifies that said access terminal rejects to delete said Personalities.

The present invention also offers a method for the access terminal responding the Delete Personality Request message in UMB technology, and the method comprises the following steps:

(1) When the access network requests to delete one or more Personalities, it sends said Delete Personality Request message to said access terminal;

(2) Said access terminal determines whether to agree to delete one or more Personalities within the request or not, if yes, determines the number of Personalities agreed to be deleted and proceeds to step (3); otherwise, proceeds to step (4);

(3) Said access terminal takes the content that it agrees to delete at least one Personality as the information of AcceptIncld, the number of the Personalities that it agrees to delete as the information of Personality Count, and one or more Personalities that it agrees to delete as the information of Personality Index, and fills the Delete Personality Response message with all these information, and sends the message to said access network;

(4) Said access terminal takes the content that it rejects to delete any Personality as the information of AcceptIncludeID, the reason for rejecting to delete the Personalities as the information of Reject Reason, fills the Delete Personality Response message with all these information, and sends the message to said access network.

Said Delete Personality Response message also comprises the following information: Message ID, Transaction ID and Reserved.

The present invention also offers a method for responding the Delete Personality Request message in the UMB technology, and said Delete Personality Request message is sent to the access terminal by the access network through said UMB air interface, and the method comprises:

When said access network requests to delete one or more Personalities, said access terminal sends a Delete Personality Response message including Message ID, Transaction ID, AcceptIncld, Reject Personality Count, Personality Index, Reserved and Reject Reason to said access network, wherein:

Said AcceptIncld is determined according to whether said access terminal agrees to delete the Personalities or not;

Said Personality Index is one or more personalities that said access terminal rejects to delete when rejecting to delete any personality;

Said Reject Personality Count is determined by said access terminal according to the number of the personalities which are rejected to be deleted.

The Reject Reason is not indicated and the Reject Personality Count is neglected when said AcceptIncld identifies that said access terminal agrees to delete all said personalities;

Said Reject Reason is indicated and the number of all personalities which are rejected to be deleted is taken as the information of said Reject Personality Count when Said AcceptIncld identifies that said access terminal rejects to delete any Personality.

The present invention also offers a method for the access terminal responding the Delete Personality Request in the UMB technology, and the method comprises the following steps:

(1) When the access network requests to delete one or more personalities, it sends said Delete Personality Request message to said access terminal;

(2) Said access terminal determines whether to agree to delete all requested personalities or not, if yes, proceeds to step (3); otherwise, proceeds to step (4);

(3) Said access terminal takes the content that it agrees to delete all personalities as the information of AcceptIncld, fills the Delete Personality Response message with the information, and sends the message to the access network;

(4) Said access terminal takes the content that it rejects to delete any personality as the information of AcceptIncld, the number of personalities that it rejects to delete as the information of Reject Personality Count, one or more personalities which it rejects to delete as the information of Personality Index, and the reason for rejecting to delete the corresponding personalities as the information of Reject Reason, fills the Delete Personality Response message with all these information, and sends the message to the access network.

Said Delete Personality Response message further comprises the following information: Message ID, Transaction ID and Reserved.

Compared with the prior art, the present invention enhances the personality management mechanism in the UMB by enhancing or extending the Delete Personality Accept message or defining a new Delete Personality Response message at the access terminal side, thus save the signaling interaction overhead of the air interface, and further save the air interface resource.

### BRIEF DESCRIPTION OF DRAWINGS

FIG. 1 is an illustration of the embodiment of negotiated Personality that eBSs have in the prior art;

FIG. 2 is an embodiment of the method for the access terminal responding the Delete Personality Request message from the access network through the enhanced Delete Personality Accept message;

FIG. 3 is an embodiment of the method for the access terminal responding the Delete Personality Request from the access network through the Delete Personality Response message;

FIG. 4 is an embodiment of the method for the access terminal responding the Delete Personality Request from the access network through the UMB air interface.

### THE PREFERRED EMBODIMENTS OF THE PRESENT INVENTION

The present invention will be described in detail with combination of the accompanying figures and the embodiments.

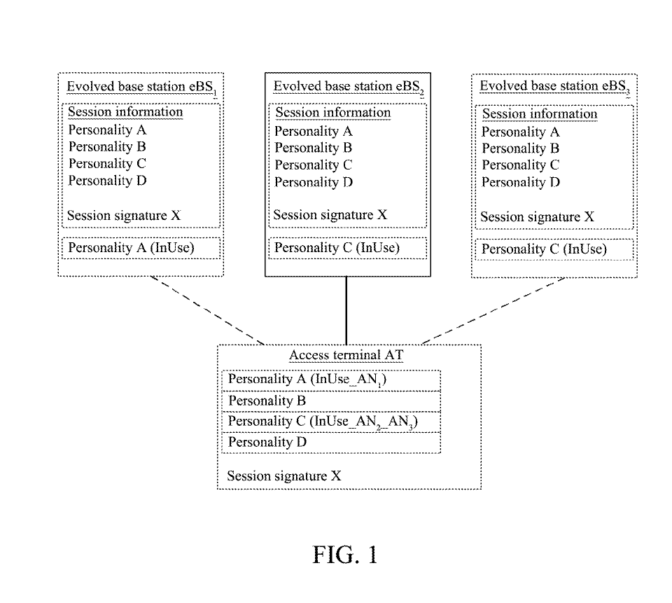

The Delete Personality Request message shown in FIG. 1 carries the Personality to be deleted as desired. However, one Delete Personality Accept message only can indicates to delete one Personality as desired in the prior art. Therefore, for a Delete Personality Request message which carries the information of deleting several Personalities as desired, the access terminal needs to send the Delete Personality Accept message to the access network for several times. In order to get rid of this technical disadvantage, the present invention offers the following two methods:

(1) Enhancing or extending the Delete Personality Accept message in the prior art to make one enhanced or extended Delete Personality Accept message include several Personalities that the access terminal accepts to delete.

(2) Defining a new air interface message which, in function, not only takes the enhanced Delete Personality Accept message in method (1) into consideration, but also carries the Delete Personality Reject message, thus can replace the Delete Personality Accept message and Delete Personality Reject message in the prior art.

The implementations of these two methods will be described in detail in the following.

Method One: Enhanced Delete Personality Accept Message

A new field, such as Personality Count field, is added in the present Delete Personality Accept message to indicate the number of Personalities that the receiver agrees to delete among the personalities in the Delete Personality Request message. Each to-be-deleted Personality is indicated by the following Personality Index. Therefore, after enhancing the Delete Personality Accept message in the prior art, the Personality Index can determines the times of appearance as desired, rather than one time in the prior art.

Table 5 shows the format of the enhanced Delete Personality Accept message:

TABLE 5
the format of the enhanced Delete Personality Accept message

| Field | Length (bits) |
|---|---|
| Message ID | 8 |
| Transaction ID | 8 |
| Personality Count | 4 |
| Reserved 1 | 4 |

Personality Count instances of the following record

| | |
|---|---|
| Personality Index | 4 |
| Reserved 2 | 0-7 as needed |

There is a blank row between Personality Index field and Reserved field in Table 5 which means that the times are counted only when Personality Index appears.

Wherein,

Message ID: the access terminal shall set it as 0x0e.

Transaction ID: the access terminal shall set this field to the value of the corresponding field in the Delete Personality Request message accepted.

Personality Count: the access terminal shall set this field to the number of Personality Index fields in this message.

Reserved 1: this field is set as 0000, and the receiver will neglect this field.

Personality Index: the access terminal shall set this field to the personality deleted.

Reserved 2: This field shall be set to reserved bits to make the length of the entire message equal to an integer number of octets. These bits shall be set to ‘0’.

Therefore, after enhancing the Delete Personality Accept message in the prior art, when the access terminal sends the Delete Personality Accept message to the access network, the information carried in the Delete Personality Accept comprises Message ID, Transaction ID, Personality Count, Personality Index and Reserved, wherein the information of Personality Count is determined by the number of the Personalities included in the message; the information of Personality Index is one or more Personalities that the access terminal agrees to delete.

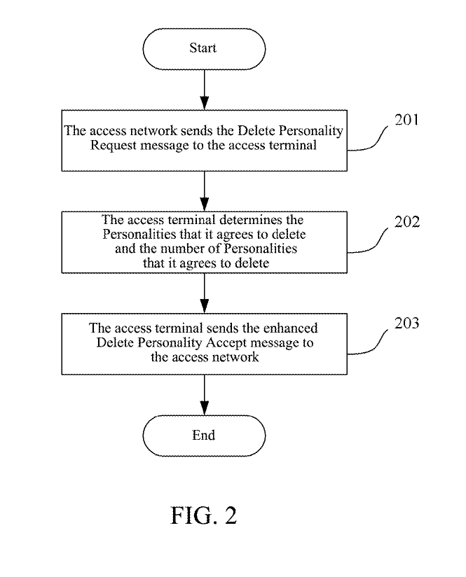

On this basis, as shown in FIG. 2, the method for the access terminal responding the Delete Personality Request from the access network through the UMB air interface comprises the following steps:

Step 201: when the access network requests to delete one or more Personalities, the access network sends the Delete Personality Request indicating the to-be-deleted Personalities to the access terminal through the UMB air interface;

Step 202: after the access terminal receives the Delete Personality Request, the access terminal determines one or more Personalities that it agrees to delete and determines the number of the Personalities it agrees to delete.

Step 203: the access terminal takes the number of Personalities carried in this message as the information of Personality Count, and the one or more Personalities that the access terminal agrees to delete as the information of Personality Index, and fills the Delete Personality Accept message with all the information, that is, the enhanced Delete Personality Accept, and sends the message to the access network.

Idea 2: Define a New Air Interface Message

This new message takes the function of the Delete Personality Accept message and the enhanced Delete Personality Accept message and that of the Delete Personality Reject message into account, thus it can replace these two messages. For example, the new message is defined as Delete Personality Response message, and after the access terminal receives the Delete Personality Request message from the access network, the access terminal sends the Delete Personality Response message as a response to indicate whether the access terminal agrees to delete at least one Personality or rejects to delete any Personality.

The format of the Delete Personality Response message is shown as Table 6:

TABLE 6
the format of the Delete Personality Response message

| Field | Length (bits) |
|---|---|
| Message ID | 8 |
| Transaction ID | 8 |
| AcceptIncld | 1 |
| Personality Count | 4 |

Personality Count instances of the following record

| | |
|---|---|
| Personality Index | 4 |
| Reserved | 0-7 as needed |
| Reject Reason | 8 |

Wherein,

Message ID: the access terminal sets it as 0x0e.

Transaction ID: the access terminal shall set this field to the value of the corresponding field in the Delete Personality Request message accepted.

AcceptIncld: The access terminal shall set this field to ‘1’ if the access terminal accepts at least one personality deletion. Otherwise, it is set to ‘0’. Personality Count: If AcceptIncld is ‘1’, the access terminal shall set this field to the number of Personality Index fields in this message. Otherwise, the access terminal ignores this field.

Personality Index: If AccptInclud is ‘1’, the access terminal shall set this field to the personality deleted. Otherwise, the access terminal ignores this field.

Reserved: This field shall be set to reserved bits to make the length of the entire message equal to an integer number of octets. These bits shall be set to ‘0’.

Reject Reason: If AccptInclud is ‘1’, the access terminal will ignore this field. Otherwise, the access terminal shall set this field to indicate the reason the Delete Personality Request message is rejected, as specified in Table 4.

Of course, the length of the above AcceptIncld is 1 bit, and its value can be reversely set. For instance, if the access terminal accepts to delete at least one Personality in the Delete Personality Request, the value of this field is set as ‘0’; otherwise, it is set as ‘1’. The AcceptIncld actually identifies two conditions: one is accepting to delete part or all of the Personalities in the Delete Personality Request message, and the other is rejecting to delete any personality mentioned in the Delete Personality Request message.

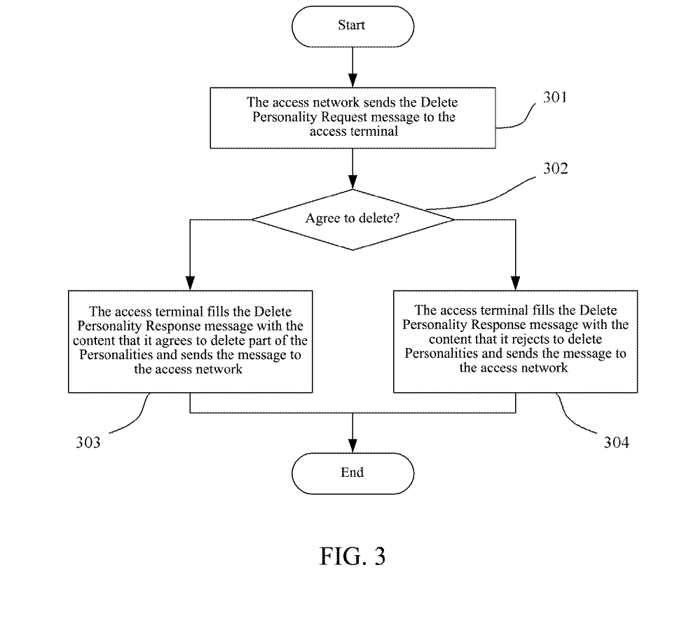

On the basis of the format shown in Table 6, the method for the access terminal responding the Delete Personality Request message from the access network through the UMB air interface shown in FIG. 3 comprises the following steps:

Step 301: when the access network requests to delete one or more Personalities, the access network sends the Delete Personality Request message indicating the to-be-deleted Personalities to the access terminal through the UMB air interface;

Step 302: after the access terminal receives the Delete Personality Request, the access terminal judges whether it agrees to delete one or more Personalities within the message or not, and determines the number of Personalities agreed to be deleted if it agrees to delete at least one Personality, and proceeds to step 303; otherwise, proceeds to step 304;

Step 303: the access terminal takes the content that it agrees to delete at least one Personality as the information of AcceptIncld, the number of Personalities agreed to be deleted as the information of Personality Count, and the one or more Personalities agreed to be deleted as the information of Personality Index, fills the Delete Personality Accept message with all these information, and sends the message to the access network.

Step 304: the access terminal takes the content that it rejects to delete any Personality as the information of AcceptIncld, and the reason for rejecting to delete the Personalities as the information of Reject Reason, fills the Delete Personality Response message with all the information, and sends the message to the access network.

Method 3: Define a New Air Interface Message

This new message takes the function of the Delete Personality Accept message and the enhanced Delete Personality Accept message as well as that of the Delete Personality Reject message into account, thus it can replace these two messages. For example, the new message is defined as Delete Personality Response message, and after the access terminal receives the Delete Personality Request message from the access network, the access terminal sends the Delete Personality Response message as a response to indicate whether the access terminal agrees to delete at least one Personality or rejects to delete any Personality.

The format of the Delete Personality Response message is shown as Table 7:

TABLE 7
the format of the Delete Personality Response message

| Field | Length (bits) |
|---|---|
| Message ID | 8 |
| Transaction ID | 8 |
| AcceptIncld | 1 |
| Reject Personality Count | 4 |
| Reserved 1 | 0~7 as needed |

Reject Personality Count instances of the following record

| | |
|---|---|
| Personality Index | 4 |
| Reserved 2 | 4 |
| Reject Reason | 8 |

Wherein,

Message ID: the access terminal set it as 0x0e.

Transaction ID: the access terminal shall set this field to the value of the corresponding field in the Delete Personality Request message accepted.

AcceptIncld: The access terminal shall set this field to ‘1’ if the access terminal accepts all personality deletion. Otherwise, it is set to ‘0’.

Reject Personality Count: If AcceptIncld is ‘0’, the access terminal shall set this field to the number of Personality Index fields in this message. Otherwise, the access terminal ignores this field.

Personality Index: If AccptInclud is ‘0’, the access terminal shall set this field to the personality deleted. Otherwise, the access terminal ignores this field.

Reserved 1 or 2: This field shall be set to reserved bits to make the length of the entire message equal to an integer number of octets. These bits shall be set to ‘0’.

Reject Reason: If AccptInclud is ‘1’, the access terminal will ignore this field. Otherwise, the access terminal shall set this field to indicate the reason the Delete Personality Request message is rejected, as specified in Table 4.

Of course, the length of the above AcceptIncld is 1 bit, and its value can be reversely set. The AcceptIncld actually identifies two conditions: one is accepting to delete all of the Personalities in the Delete Personality Request message, and the other is accepting to delete part of the Personalities mentioned in the Delete Personality Request message or rejecting to delete any personality mentioned in the Delete Personality Request message. The description of the above value 0 or 1 does not mean a limit to the present invention.

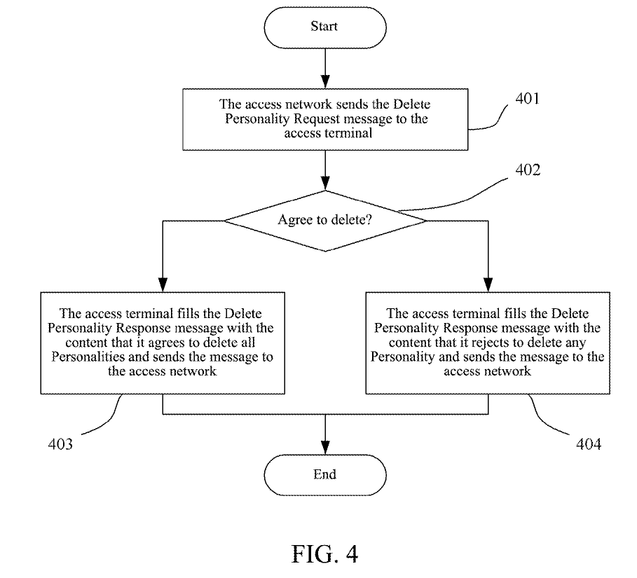

On the basis of the format shown in Table 7, the method for the access terminal responding the Delete Personality Request message from the access network through the UMB air interface shown in FIG. 4 comprises the following steps:

Step 401: when the access network requests to delete one or more Personalities, the access network sends the Delete Personality Request message indicating the to-be-deleted Personalities to the access terminal through the UMB air interface;

Step 402: after the access terminal receives the Delete Personality Request, the access terminal judges whether it agrees to delete all Personalities included within the message or not, if yes, proceeds to step 403; otherwise, proceeds to step 404;

Step 403: the access terminal takes the content that it agrees to delete all Personalities as the information of AcceptIncld with the value being set as 1, fills the Delete Personality Accept message with the information, and sends the message to the access network.

Step 404: the access terminal takes the content that it rejects to delete any Personality as the information of AcceptIncld with the value being set as 0, the number of Personalities that it rejects to delete as the information of Reject Personality Count, one or more Personalities that it rejects to delete as the information of Personality Index, and the reason for rejecting to delete the corresponding Personalities as the information of Reject Reason, fills the Delete Personality Response message with all these information, and sends the message to the access network.

The description of the above values 0 or 1 in this embodiment does not mean to limit the present invention, and the values can be used reversely.

Compared with the prior art, the present invention enhances the Personality management mechanism and it has the following advantages:

The above method one enhances the Personality management mechanism through enhancing or extending the Delete Personality Accept message in the prior art. For the request for deleting several Personalities, the access terminal can indicate that it accepts to delete several Personalities through an enhanced Delete Personality Accept message. Therefore, the method not only clears the confusion in the prior art, but also makes the management technology between the access terminal and the access network more instinct and effective, and also avoids redundant feedbacks for the same Delete Personality Request message through the air interface in prior art, therefore, the method effectively saves the signaling interaction overhead of the air interface, and thus saves the precious air interface resource.

The above method two responses the Delete Personality Request message from the access network by defining a new Delete Personality Response message at the access terminal side, and the method can not only display one or more Personalities to be deleted at one time, but also display the information associated to the Personalities that the access terminal rejects to delete, thus save the signaling interaction overhead of the air interface and the precious air interface resource.

The above method three defines a new air interface message which takes the functions of the Delete Personality Accept message and the enhanced Delete Personality Accept message as well as the function of the Delete Personality Reject message into account, thus can replace these two messages.

### INDUSTRIAL APPLICABILITY

The method for the access terminal responding the Delete Personality Request from the access network in the UMB technology disclosed in the present invention can solve the problem that the access terminal can only feed back the Delete Personality Accept message for deleting one Personality at one time when responding the Delete Personality Request message from the access network in the prior art. Thus, when applying said method of the present invention to solve the problem that the access network requests to delete one or more Personalities, the access terminal sends a Delete Personality Accept message carrying the information of Personality Count, Personality Index and the like to the access network. The present invention enhances the Personality management mechanism in the UMB system and saves the signaling interaction overhead of the air interface and the air interface resource.

1. A method for responding a Delete Personality Request message in Ultra Mobile Broadband, and said Delete Personality Request message is sent to an access terminal by an access network through an air interface of said Ultra Mobile Broadband, wherein:
when said access network requests to delete one or more Personalities, said access terminal sends a Delete Personality Accept message including Message ID, Transaction ID, Personality Count and Personality Index to said access network, wherein:
said Personality Index is one or more personalities that said access terminal agrees to delete;
said Personality Count is determined by a number of the Personalities that said access terminal agrees to delete included in said Delete Personality Accept message.

2. A method of claim 1, wherein:
said Personality Count is the number of the Personalities that said access terminal agrees to delete included in said Delete Personality Accept message.

3. A method for an access terminal responding a Delete Personality Request message in Ultra Mobile Broadband, wherein the method includes the following steps:
when an access network requests to delete one or more Personalities, the access network sends said Delete Personality Request message to said access terminal;
said access terminal determines one or more Personalities which are agreed to be deleted, and then determines a number of the Personalities agreed to be deleted;
said access terminal takes the number of the Personalities agreed to be deleted as information of Personality Count, the one or more Personalities agreed to be deleted as the information of Personality Index, and fills a Delete Personality Accept message with all the information, and sends the Delete Personality Accept message to said access network.

4. A method of claim 3, wherein:
the information carried in said Delete Personality Accept message also comprises Message ID, Transaction ID and Reserved.

5. A method for responding a Delete Personality Request in Ultra Mobile Broadband, and said Delete Personality Request is sent to an access terminal by an access network through an air interface of said Ultra Mobile Broadband, wherein:
when said access network requests to delete one or more Personalities, said access terminal sends a Delete Personality Response message including Message ID, Transaction ID, AcceptIncld, Personality Count, Personality Index and Reject Reason to said access network, wherein:
said AcceptIncld is determined according to whether said access terminal agrees to delete the Personalities or not;
said Personality Index is one or more Personalities that said access terminal agrees to delete;
said Personality Count is determined by said access terminal according to a number of the Personalities agreed to be deleted.

6. A method of claim 5, wherein said Personality Count is the number of said Personalities that said access terminal agrees to delete.

7. A method of claim 5, wherein:
said Reject Reason is not indicated if said AcceptIncld identifies that said access terminal agrees to delete said Personalities;
said Personality Count is not indicated if said AcceptIncld identifies that said access terminal rejects to delete said Personalities.
